(19) United States
(12) Patent Application Publication
(10) Pub. No.: US 2026/0223807 A1
(43) Pub. Date: Aug. 6, 2026

(54) A MILK TEXTURING DEVICE

(71) Applicant: BREVILLE PTY LIMITED, Alexandria, New South Wales (AU)

(72) Inventors: Duncan Bruce HELLMERS, Lane Cove (AU); Stephen John MCCLEAN, Camden South (AU); Johnson THIE, Alexandria, New South Wales (AU)

(21) Appl. No.: 19/154,331

(22) PCT Filed: Feb. 7, 2024
(86) PCT No.: PCT/AU2024/050078

§ 371 Date: Aug. 6, 2025

(30) Foreign Application Priority Data
Feb. 7, 2023 (AU) 2023900297

(51) Int. Cl. A01J 11/04; A47J 31/44; A47J 31/60; A47J 43/044; A47J 43/07; A47J 43/12; B01F 23/233; B01F 27/112; B01F 27/806; B01F 27/90; B01F 35/21; B01F 101/07

(52) U.S. Cl. CPC A01J 11/04; A47J 31/4489; A47J 31/60; A47J 43/044; A47J 43/0711; A47J 43/127; B01F 23/23313; B01F 27/112; B01F 27/806; B01F 27/90; B01F 35/2115; A47J 2043/04472; B01F 2101/07; B01F 2215/0431

(57) ABSTRACT

There is disclosed herein a milk texturing device (10) for texturing milk in a container (86), the device (10) including: a base assembly (12); a stem assembly (14) extending from the base assembly (12); a head assembly (16) mountable to the stem assembly (14); and a texturing assembly (30) mountable to the head assembly (16) and including: a motor (38) having an output shaft (40) that is rotatably driven about a longitudinal axis (42) of the shaft (40); an impeller assembly (50) rotatably driven by the shaft (40) and arranged to be submerged in the milk in the container (18) during use, wherein rotation of the impeller (50) assembly causes circulation of milk within the container (18); and a wand (32) extending along the longitudinal axis (42) and having an open end portion that at least partly surrounds the impeller assembly (50), wherein the milk texturing device (10) further includes a conduit (70) defining a passage for fluid flow and configured to provide fluid communication between a fluid supply and the open end portion of the wand (32) and thereby to the impeller assembly (50).

### CROSS-REFERENCE TO RELATED APPLICATION

This application claims priority to Australian Patent Application No. 2023900297, filed on 7 Feb. 2023. The entire disclosure of Australian Patent Application No. 2023900297 is hereby incorporated by reference in its entirety and for all purposes.

### FIELD

The present invention relates to milk frothing or texturing. In particular, the invention relates to a milk texturing device which incorporates various forms of frothing or texturing mechanisms.

The invention has been developed primarily for use with milk texturing devices, and will be described hereinafter with reference to these applications. However, it will be appreciated that the invention is not limited to this particular field of use, and may also be employed in other applications involving frothing or texturing of liquids.

### BACKGROUND

Devices to froth and/or texture milk are known. Texturing is adding air bubbles to milk, and heated and textured milk is used to make popular milk-based coffee beverages such as cappuccinos and lattes. An example of a known milk frothing device is disclosed in International Publication No. WO 2019/090379, which textures milk by way of an impeller and heats milk by induction. Other forms of milk frothing or texturing devices include conventional steam wands attached to coffee machines, or handheld milk frothing whisks.

A disadvantage of known milk frothing or texturing devices is that heat by steaming is typically required to create a desired level of texture in the milk. Such devices may therefore be unsuitable for providing textured milk for cold drinks such as tea lattes and milkshakes. The heating methods employed by such devices may also be less suitable for alternative milks such as oat milk and almond milk. Mechanical milk texturing devices such as milk frothing whisks, on the other hand, may not introduce an adequate amount of air or air bubbles to the milk, which may result in poorly textured milk having an undesirable (typically flat) texture, thereby detracting from the taste of the milk and ultimately the flavour of the beverage being consumed. Known mechanical milk texturing devices are also susceptible to creating uneven frothing or too much foaming in the milk, leading to a “meringue effect” whereby an undesirable clump or dollop of milk froth can fall out during the pouring process when creating the beverage due to poor texture integration.

Throughout the specification, the term ‘milk’ will be understood as including dairy milk and non-dairy milk such as soy milk, hazelnut milk, coconut milk, goats' milk or other ‘milks’ that may be textured by steam to prepare a hot beverage.

### SUMMARY

It is an object of the present invention to substantially overcome, or at least ameliorate, one or more of the disadvantages of existing arrangements, or at least provide a useful alternative to existing arrangements.

There is disclosed herein a milk texturing device for texturing milk in a container, the device including:
a base assembly;
a stem assembly extending from the base assembly;
a head assembly mountable to the stem assembly; and
a texturing assembly mountable to the head assembly and including:
   a motor having an output shaft that is rotatably driven about a longitudinal axis of the shaft;
   an impeller assembly rotatably driven by the shaft and arranged to be submerged in the milk in the container, wherein rotation of the impeller assembly causes circulation of milk within the container; and
   a wand extending along the longitudinal axis and having an open end portion that at least partly surrounds the impeller assembly,
wherein the milk texturing device further includes a conduit defining a passage for fluid flow and configured to provide fluid communication between a fluid supply and the open end portion of the wand and thereby to the impeller assembly.

The fluid supply may be one or more of an air supply, a steam supply, or open to atmosphere, and the fluid supply includes one or more valves that are actuatable to provide selective fluid communication with the conduit.

The wand may include a first annular space through which the conduit extends and a second annular space within which the impeller assembly is located.

The conduit may include an inlet end portion in fluid communication with the fluid supply and an outlet end portion in fluid communication with the second annular space of the wand within which the impeller assembly is located.

The wand may further include an annular member disposed between the first annular space and the second annular space to provide a seal therebetween.

The seal between the first annular space and the second annular space may be provided by a bearing member mountable to the annular member.

The conduit may extend along a longitudinal axis that is parallel to the longitudinal axis of the shaft.

The end portion of the wand may include a plurality of apertures providing a perforated or caged member through which the milk may flow.

Each of the apertures may have a diameter of at least 0.3 mm. In one form, each of the apertures may have a diameter of between 0.3 and 1.0 mm.

The milk texturing device may further include a temperature sensor disposed adjacent the end portion of the wand.

The temperature sensor may be located diametrically opposite to the conduit about the longitudinal axis.

The head assembly may be movable between a raised position and a lowered position relative to the base assembly.

There is further disclosed herein a method of operating a milk texturing device, the method including the steps of:

enabling a motor to drive a rotation of an impeller assembly of the milk texturing device to circulate milk in a container; and

opening an air valve of the milk texturing device to introduce air into the milk from an air supply.

The method may further include the step of:
prior to enabling the motor, receiving a user input relating to one or more settings relating to a texture level or temperature of the milk being textured.

The method may further include the steps of:
determining a quality of the milk being textured; and
closing the air valve of the milk texturing device after the milk being textured reaches a certain texture level.

The method may further include the step of:
closing the air valve of the milk texturing device after the air valve has been open for a period of time.

The method may further include the step of:
opening a steam valve of the milk texturing device to introduce steam into the milk from a steam supply to thereby heat the milk.

The method may further include the step of:
closing the steam valve of the milk texturing device after the milk being textured reaches a certain temperature.

The method may further include the step of:
disabling the motor and thereby rotation of the impeller assembly to complete a texturing cycle of the milk texturing device.

The method may further include the step of commencing a cleaning cycle following the completion of the texturing cycle, wherein the cleaning cycle includes the steps of:
opening the steam valve of the milk texturing device; and
enabling the motor to drive rotation of the impeller assembly at a low speed.

The steam valve may be opened and the motor may be configured to drive the rotation of the impeller assembly for a period of time.

The method may further include the step of:
closing the steam valve following the opening of the steam valve and the rotation of the impeller assembly for the period of time; and
disabling the motor and thereby the rotation of the impeller assembly to complete the cleaning cycle of the milk texturing device.

There is also disclosed herein a non-transitory computer storage medium storing instructions that, when executed by one or more processors of a milk frothing device described above, causes the one or more processors to perform a method of operating the milk frothing device.

There is also disclosed herein a texturing assembly for texturing or frothing milk in a container, the texturing assembly including:
a wand having an end portion including a plurality of apertures;
an impeller assembly having a central longitudinal axis and including a plurality of vanes, the impeller assembly being powered by a drive unit, and the plurality of vanes being surrounded by the plurality of apertures; and
a conduit defining a passage for steam or air flow, wherein the conduit extends along a longitudinal axis that is generally parallel to the central longitudinal axis of the impeller assembly.

A portion of the conduit may extend along a direction that is transverse to the longitudinal axis.

There is also disclosed herein a method of texturing milk in a container using a texturing assembly, the method including the steps of:
rotating an impeller assembly of the texturing assembly to circulate milk in the container;
introducing steam or air into the milk via a wand of the texturing assembly, the wand having an end portion including a plurality of apertures surrounding the impeller assembly; and
texturing the milk by circulating the milk through the plurality of apertures surrounding the impeller assembly.

### BRIEF DESCRIPTION OF THE DRAWINGS

For a more complete understanding of the present invention, exemplary embodiments of the invention are explained in more detail in the following description with reference to the accompanying drawing figures, in which like reference signs designate like parts and in which:

FIG. 1 is a schematic side view of an embodiment of a milk texturing device, with a texturing assembly in a raised position;

FIG. 2 is a schematic side view of an embodiment of the milk texturing device shown in FIG. 1, with the texturing assembly in a lowered position;

FIG. 3 is a schematic sectioned side view of the texturing assembly of the milk texturing device shown in FIG. 1, with the texturing assembly in the lowered position;

FIG. 4 is a further schematic sectioned side view of the texturing assembly shown in FIG. 3, with the texturing assembly in a lowered position, and showing flow patterns in the jug; and

FIG. 5 is a further schematic sectioned side view of the texturing assembly shown in FIG. 3;

FIG. 6 is a schematic partial sectioned side view of the texturing assembly shown in FIG. 3;

FIG. 7 is a schematic partial sectioned side view of an embodiment of the texturing assembly shown in FIG. 3;

FIG. 8 is a schematic partial isometric view of the texturing assembly shown in FIG. 3:

FIG. 9 is a schematic bottom view of the texturing assembly shown in FIG. 3;

FIG. 10 is a schematic bottom isometric view of the texturing assembly shown in FIG. 3;

FIG. 11 is a schematic bottom isometric view of an impeller assembly of the texturing assembly shown in FIG. 3;

FIG. 12 is a schematic top isometric view of the impeller assembly shown in FIG. 10;

FIG. 13 shows a method or logic system of the milk texturing device;

FIG. 14 is a schematic bottom view of an embodiment of a texturing assembly;

FIG. 15 is a schematic sectioned side view of an embodiment of a texturing assembly;

FIG. 16 is a schematic sectioned side view of an embodiment of a texturing assembly shown in a lowered position;

FIG. 17 is a schematic sectioned side view of the embodiment of the texturing assembly of FIG. 16, shown in a lowered position;

FIG. 18 is a schematic sectioned side view of an embodiment of a texturing assembly

FIG. 19 is a schematic isometric view of an embodiment of a texturing assembly;

FIG. 20 is a schematic sectioned isometric view of the texturing assembly shown in FIG. 19;

FIG. 21 is a schematic sectioned side view of the texturing assembly shown in FIG. 19;

FIG. 22 is a further schematic sectioned side view of the texturing assembly shown in FIG. 19; and

FIG. 23 is a further schematic sectioned side view of the texturing assembly shown in FIG. 19.

### DETAILED DESCRIPTION

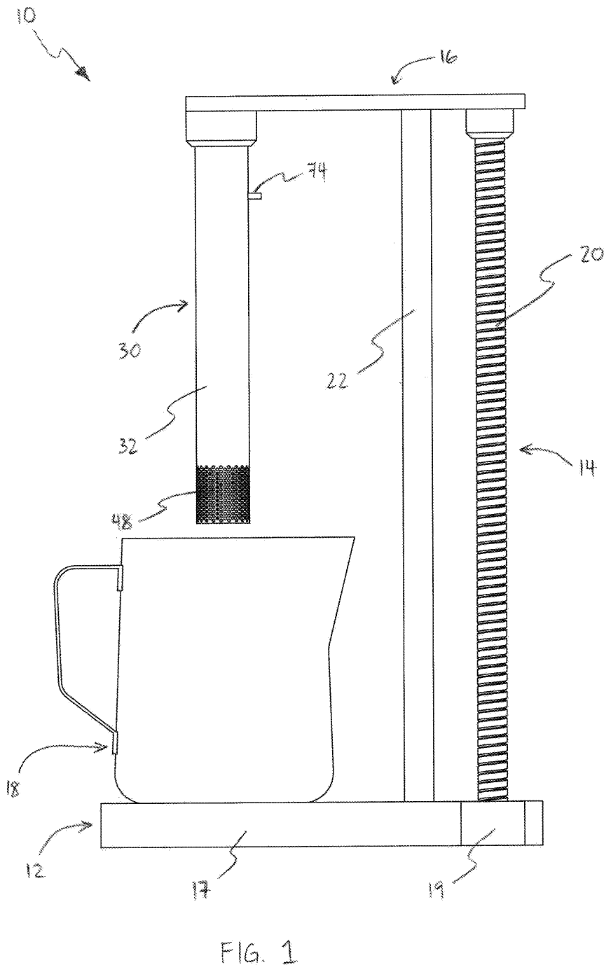

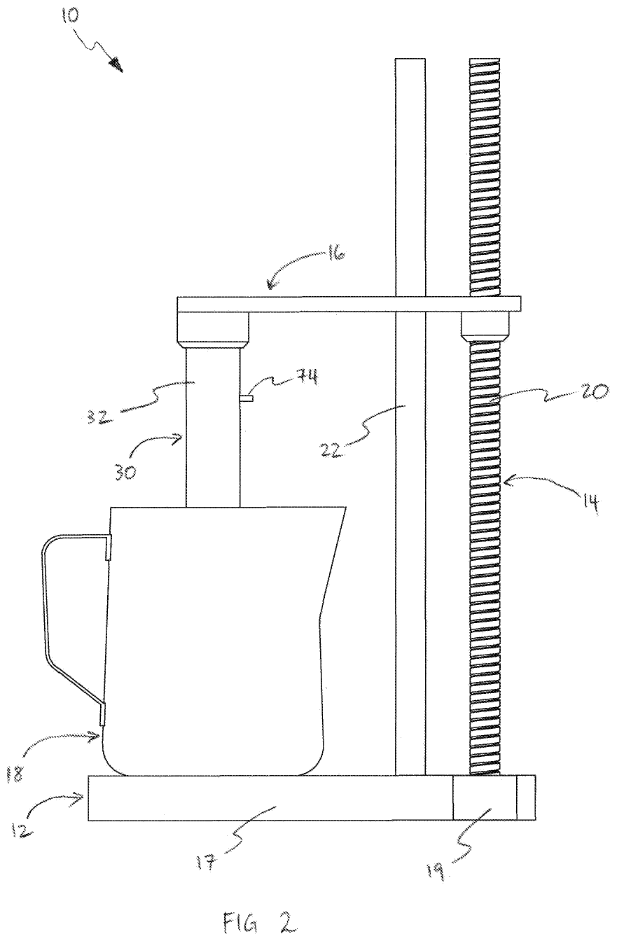

In FIGS. 1 and 2 of the accompanying drawings, there is schematically depicted an embodiment of a milk texturing (frothing) device 10. In the depicted embodiment, the milk texturing device 10 is shown as a free-standing device having a base assembly 12, a stem assembly 14, and a head assembly 16. It will, however, be appreciated that in other embodiments (not shown), the milk texturing device 10 may be incorporated into a coffee machine or other suitable appliance. It will be further appreciated that the configuration of the milk texturing device 10 is not necessarily limited to the configuration as shown in the drawings, and may be customised or adjusted depending on the design requirements of the device 10 or the appliance to which it is incorporated.

The base assembly 12 includes a housing 17 adapted to accommodate, or receive, a vessel or container such as a milk jug 18, and may also include a motor 19 operably associated with the stem assembly 14. The housing 17 may be in the form of a drip tray or other suitable base member. The motor 19 may be in communication with a processor (not shown) of the milk texturing device 10 or of the coffee machine or other appliance in which the milk texturing device 10 may be incorporated. The stem assembly 14 extends generally upwardly from the base assembly 12 and may include a lead screw 20 (or the like) for raising and lowering the head assembly 16 and a guide rod 22 for guiding and/or locating the movement of the head assembly 16. The head assembly 16 may be movable between a raised position relative to the base assembly 12, such as the position shown in FIG. 1, and a lowered position relative to the base assembly 12, such as the position shown in FIG. 2. The movement of the head assembly 16 between the raised and lowered positions may be driven by the motor 19 rotating the lead screw 20, or may be manually driven by a user. The motor 19 may be included with the base assembly 12 or with the head assembly 16. It will thus be appreciated that, in such embodiments, the milk texturing device 10 is height-adjustable to accommodate a variety of jug (container) sizes and/or to accommodate the amount of milk inside the jug or the stage of the milk texturing cycle. By way of example, the head assembly 16 may be raised before the user inserts or places the jug, lowered to initiate texturing of milk in the jug, raised when the user removes the jug, and lowered for cleaning. In other embodiments (not shown), the stem assembly 14 and the head assembly 16 may be provided in a fixed position relative to the base assembly 12, whereby the lead screw 20 and/or the guide rod 22 are not required for height adjustability.

The milk texturing device 10 further includes a texturing assembly 30 that is mountable to the head assembly 16 so as to be located above the base assembly 12. In the raised position as shown in FIG. 1, the milk jug 18 is located on the base assembly 12 so as to be directly below and spaced from the texturing assembly 30. In the lowered position as shown in FIG. 2, a portion of the texturing assembly 30 is shown to be inside the milk jug 18. In other embodiments, the texturing assembly 30 may be mountable to a coffee machine or other appliance, whereby one or more components of the base assembly 12 and/or the head assembly 16 are incorporated into the coffee machine. In yet other embodiments, the texturing assembly 30 may be pivotable relative to the head assembly 16 and in such embodiments, the stem assembly 14 may not necessarily require height-adjustability by way of the lead screw 20 and/or the guide rod 22 and may be provided in a fixed position relative to the base assembly 12. In yet other embodiments, the texturing assembly 30 may be detachable or removable from the coffee machine or other appliance.

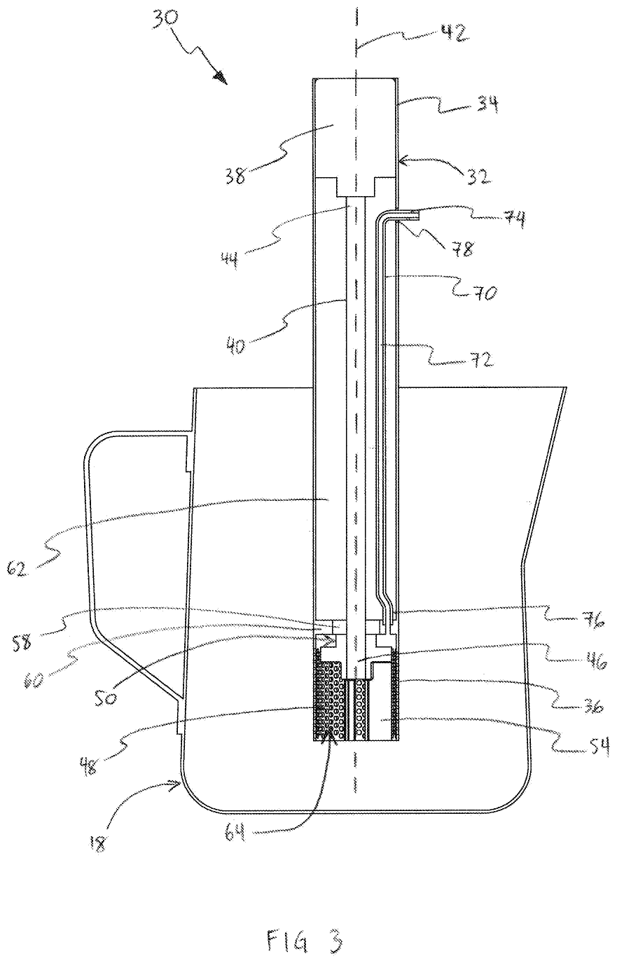

As best shown in FIGS. 3 to 5, the depicted embodiment of the texturing assembly 30 includes a texturing wand 32 in the form of an elongated tube or sleeve having a first end portion 34 disposed adjacent the head assembly 16 and an opposing second end portion 36, which is the free end of the texturing wand 32. The texturing assembly 30 further includes a motor (drive unit) 38 located adjacent the first end portion 34 and an output shaft 40 that is operably associated with the motor 38. The motor 38 may be in communication with the processor of the milk texturing device 10 or of the coffee machine or other appliance in which the milk texturing device 10 may be incorporated. In a preferred form, the motor 38 may be enabled to rotatably drive the shaft 40 about a longitudinal axis 42 so as to have a rotational speed of up to approximately 15,000 rpm. It will be appreciated that, in use, the shaft 40 may be rotated at a sufficiently high speed so as to allow the associated impeller assembly (described in detail below) to generate its own suction, which may thereby eliminate the need for a separate air pump. It is understood that suction may begin at approximately 5,000 rpm, depending on the viscosity of the liquid. It will further be appreciated that in other embodiments, the rotational speed of the motor 38 may be customised or adjusted depending on the design requirements of the device 10 or the appliance to which it is incorporated, and typically corresponds to the diameter of the associated impeller assembly described in further detail below.

The shaft 40 includes a first end portion 44 that is mountable to the motor 38 and an opposing second end portion 46. For the purposes of this specification, it will be appreciated that various components of the texturing assembly 30 (e.g. the texturing wand 32 and the shaft 40) and other components described below may share a common longitudinal axis, being the longitudinal axis 42.

In the depicted embodiment, the second end portion 36 of the texturing wand 32 is open and may include a plurality of radial passages or apertures 48 to as to provide a perforated or caged portion through which milk may flow. Each aperture 48 may have a diameter of between approximately 0.3 and 1.0 mm. It will be appreciated that the size, configuration, and the number of apertures 48 is not necessarily limited to the configuration as shown in the drawings and as described, and may be customised or adjusted depending on the design requirements of the milk texturing device 10 or the appliance to which it is incorporated.

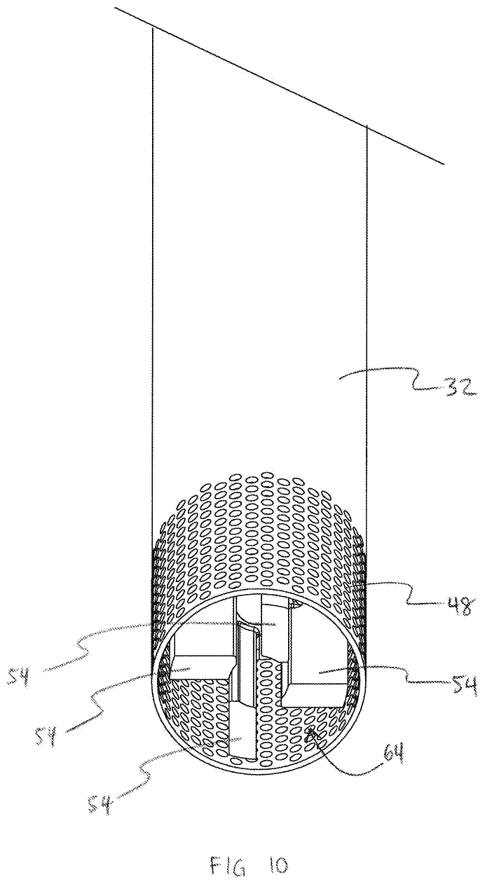

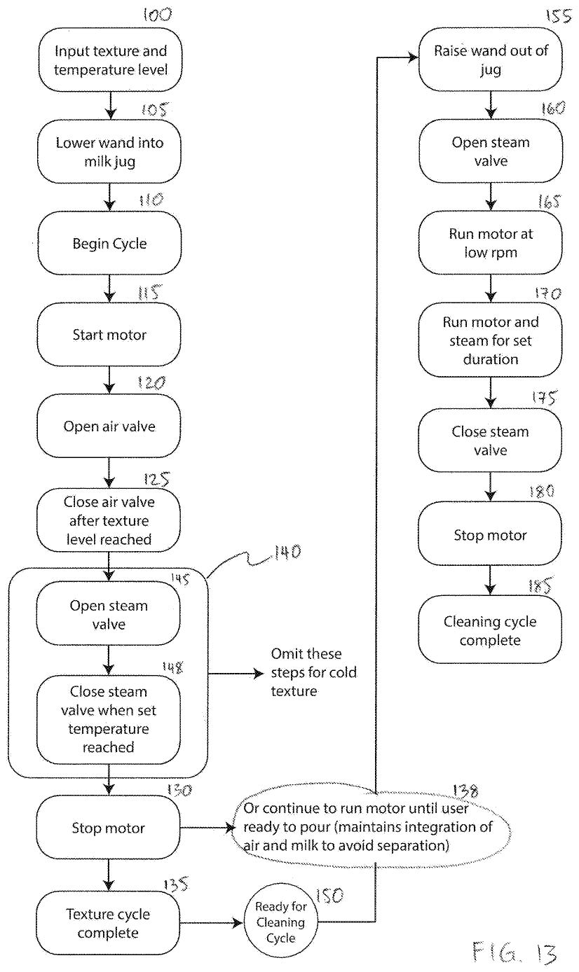

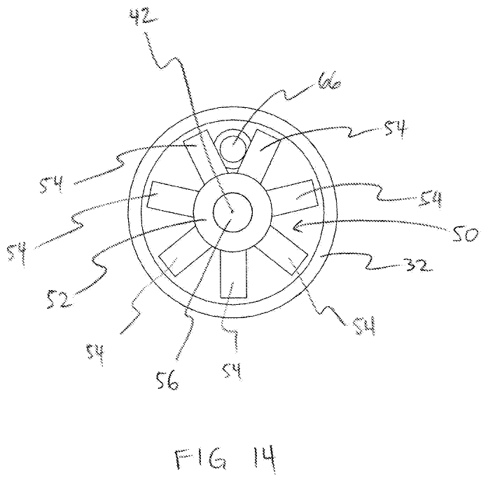

The texturing assembly 30 further includes an impeller assembly 50 that is mountable to the second end portion 46 of the shaft 40 so as to be surrounded, at least in part, by the plurality of apertures 48 and spaced radially therefrom. In other words, the impeller assembly 50 is surrounded, at least in part, by the perforated or caged portion of the texturing wand 32. It will be understood that rotation of the shaft 40 causes rotation of the impeller assembly 50 about the longitudinal axis 42. As best shown in FIGS. 8 to 12, the impeller assembly 50 includes a hub 52 and one or more blades (vanes) 54 extending radially outwardly from the hub 52. In the depicted embodiment, the impeller assembly 50 includes four blades 54 extending from the hub 52. Each blade 54 may extend from the hub 52 such that an edge of the blade 54 may be offset from the central axis 42 by a distance D. The blade 54 may be designed so as to have a leading edge and a trailing edge to facilitate frothing/texturing of the milk. It will, however, be appreciated that the number of blades 54 is necessarily limited to the quantity or configuration as shown in the drawings and described herein, and may be adjusted depending on the design requirements of the device 10 or the appliance to which it is incorporated. With reference to FIG. 14, for example, and as will be described in further detail below, the impeller assembly 50 is shown with seven blades 54. The one or more blades 54 may be integrally or separately formed from the hub 52.

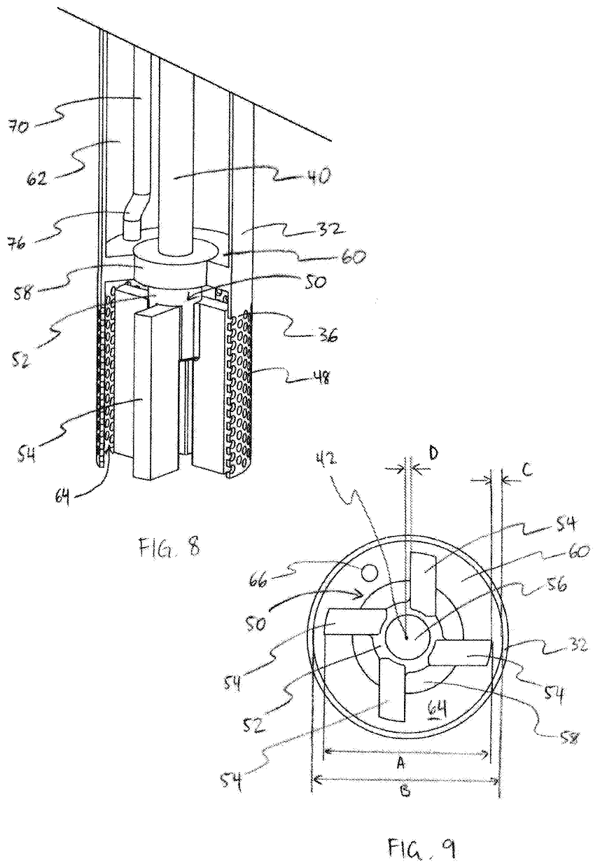

With reference to FIG. 9, the depicted embodiment of the impeller assembly 50 may have a diameter A of between approximately 10 and 24 mm (measured from the radial extremities of the blades or vanes 54). The texturing wand 32 may have an inner diameter B of between approximately 10 and 28 mm such that the extremities of the blades or vanes 54 are radially spaced from the texturing wand 32 by a distance C of between approximately 0.1 and 2 mm. It will be understood that the dimensions of the impeller assembly 50 and texturing wand 32 are not necessarily limited to the dimensions indicated above, and may be adjusted depending on the design requirements of the milk texturing device 10 or the appliance to which it is incorporated. As described above, the rotational speed of the motor 38 may be adjusted depending on the dimensions of the impeller assembly 50 and/or the texturing wand 32.

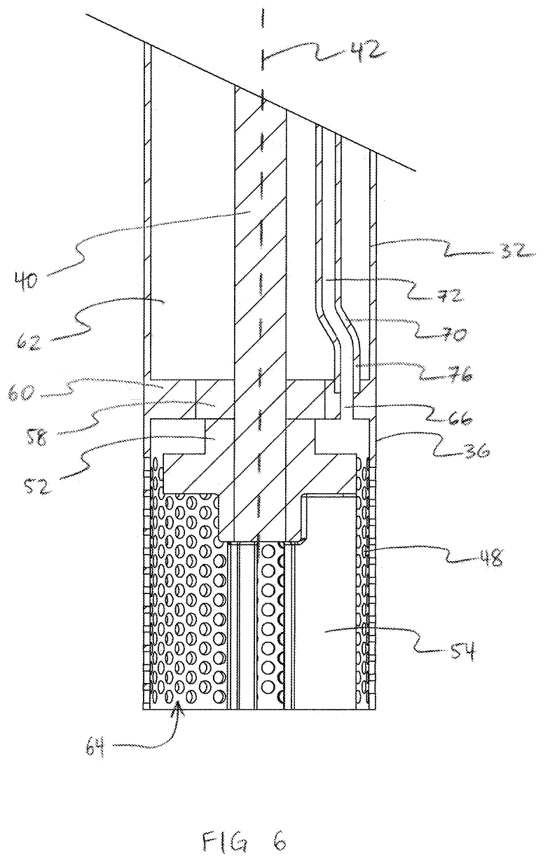

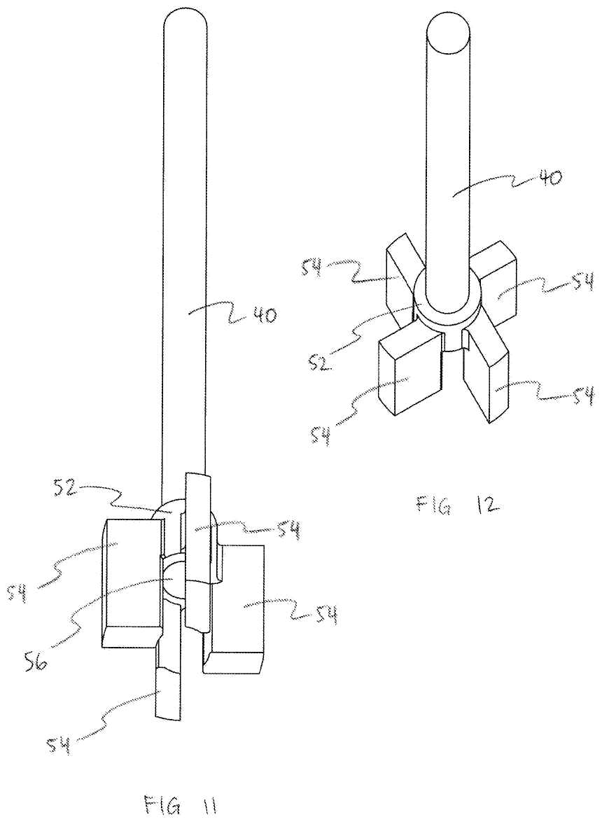

As shown in FIGS. 9 and 11, in the depicted embodiment of the impeller assembly 50, the hub 52 may include a central aperture 56 to facilitate the attachment of the impeller assembly 50 to the shaft 40. Returning to FIGS. 6 to 8, in one or more embodiments, the texturing assembly 30 may also include a bearing member 58 disposed adjacent the hub 52. In a preferred form, the texturing wand 32 may include an annular member 60 located towards the second end portion 36 (adjacent the plurality of apertures 48) and that extends radially inwardly from an inner wall of the texturing wand 32. The annular member 60 may extend from the inner wall of the texturing wand 32 in a direction transverse to the longitudinal axis 42 and preferably includes a central aperture within which the bearing member 58 is located. The bearing member 58 may be mounted within the central aperture of the annular member 60 so to be supported therein and sealed between the first end portion 34 and the second end portion 36 of the texturing wand 32.

In particular, in one or more embodiments, the bearing member 58 may be mounted within the central aperture of the annular member 60 so as to provide a seal between a first annular space 62 and a second annular space 64 of the texturing wand 32. It will thus be appreciated that, in use, the first annular space 62 may be kept dry or isolated from liquids in which the texturing wand 32 is partially submerged. The second annular space 64 is surrounded, at least in part, by the plurality of apertures 48 and provides the space in which the impeller assembly 50 is located. The annular member 60 may also include one or more through holes 66 that provide a path between the first and second annular spaces 62 and 64, as will be described in further detail below. It will also be appreciated that in other embodiments, the seal between the first annular space 62 and the second annular space 64 may be achieved using other methods, and is not limited to the configuration of the bearing member 58 and/or the annular member 60 as shown and as described above.

Returning to the embodiment as depicted in FIG. 14 (in which the impeller assembly 50 includes seven blades 54). In this embodiment, the blades 54 extend radially outwardly from the central axis 42 such that they are not necessarily offset therefrom. It will be appreciated that in such embodiments, there are no directional limitations with the blades 54 such that the impeller assembly 50 may rotate in either clockwise or counter-clockwise direction about the axis 42. It is understood that in such embodiments, the “mirror image” of stress in opposing blades 54 may be reduced, which can lead to a lessening of vibrations caused during rotation of the impeller assembly 50. Further, in such embodiments, the gap or distance between each blade 54 may be reduced, thereby accommodating for a smaller volume of liquid between the blades 54. It will be appreciated that one or more of the above arrangements may at least allow for better (or at least more even) texture integration during the frothing/texturing process. Again, as discussed above, the number of blades 54 is necessarily limited to the quantity or configuration as shown in the drawings and described herein, and may be adjusted depending on the design requirements of the device 10 or the appliance to which it is incorporated.

As best shown in FIGS. 3 to 8, the texturing assembly 30 may further include a conduit or tube 70 defining a passage 72 which extends between a first (inlet) end portion 74 and an opposing second (outlet) end portion 76 of the conduit 70. The first end portion 74 of the conduit 70 may extend through an aperture 78 located adjacent the first end portion 34 of the texturing wand 32 such that the passage 72 provides fluid communication between the annular space(s) 62 and 64 of the texturing wand 32 and the exterior of the wand 32. In a preferred form, the conduit 70 extends along a longitudinal axis that is arranged to be parallel to the longitudinal axis 42 of the components of the texturing assembly 30 described above.

In the depicted embodiment, the first end portion 74 of the conduit 70 is arranged to extend in a direction transverse to its longitudinal axis (and also the longitudinal axis 42), and is adapted to provide fluid communication between the passage 72 and a steam supply 80 and/or an air supply 82 and/or to the atmosphere surrounding the texturing assembly 30. In a preferred form, the steam supply 80 (and associated passages) is independent of the air supply 82 (and associated passages) or the atmosphere such that selective supply of steam or air may be provided to the passage 72.

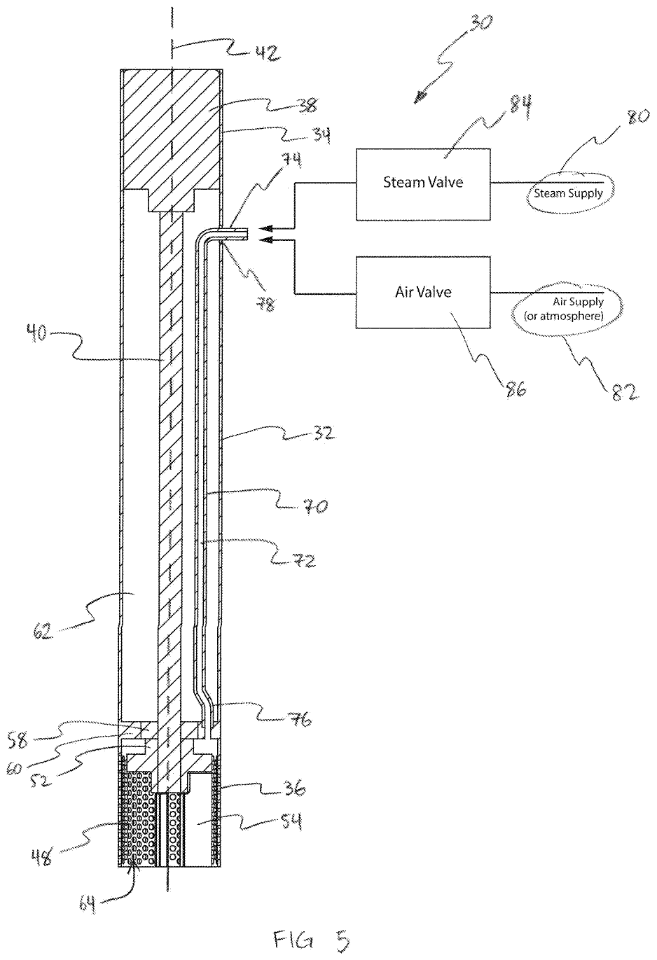

Referring to FIG. 5, a steam valve 84 may be located between the steam supply 80 and the first end portion 74 of the conduit 70 and similarly, an air valve 86 may be located between the air supply 82 (or the atmosphere) and the first end portion 74 of the conduit 70. In embodiments whereby the milk texturing device 10 is incorporated into a coffee machine or other appliance, it will be appreciated that the steam supply of the coffee machine or other appliance may be diverted to provide the steam supply 80 of the milk texturing device 10. The steam valve 84 and the air valve 86 are each selectively actuatable to provide selective fluid communication from the respective steam supply 80 and air supply 82 to the conduit 70.

As shown in the Figures, the conduit 70 may be arranged to extend substantially through the first annular space 62 of the texturing wand 32, whereby the first end portion 74 is located about or adjacent the first end portion 34 of the texturing wand 32 as described above, and the second end portion 76 is located about or adjacent the second end portion 36 of the texturing wand 32. As best shown in FIG. 6, the second end portion 76 of the conduit 70 may be mounted to the annular member 60 so as to partially surround one of the through holes 66. In the depicted embodiment, the second end portion 76 is mounted partially within a cavity of the annular member 60 which surrounds the through hole 66. However, in other embodiments (not shown), the second end portion 76 may extend entirely through the through hole 66. It will be understood that the second end portion of the conduit 70 may be located in such a way that it does not interfere with the blades or vanes 54 of the impeller assembly 50.

It will thus be understood that in this embodiment, the passage 72 is in fluid communication with the through hole 66 and therefore the second annular space 64 of the texturing wand 32. The passage 72 may therefore provide fluid communication between the steam supply 80 and/or the air supply 82 and/or the atmosphere and the second annular space 64, which is where the impeller assembly 50 is located. The second end portion 76 of the conduit 70 may also include one or more bends or diversions to control the flow of fluid through the passage 72.

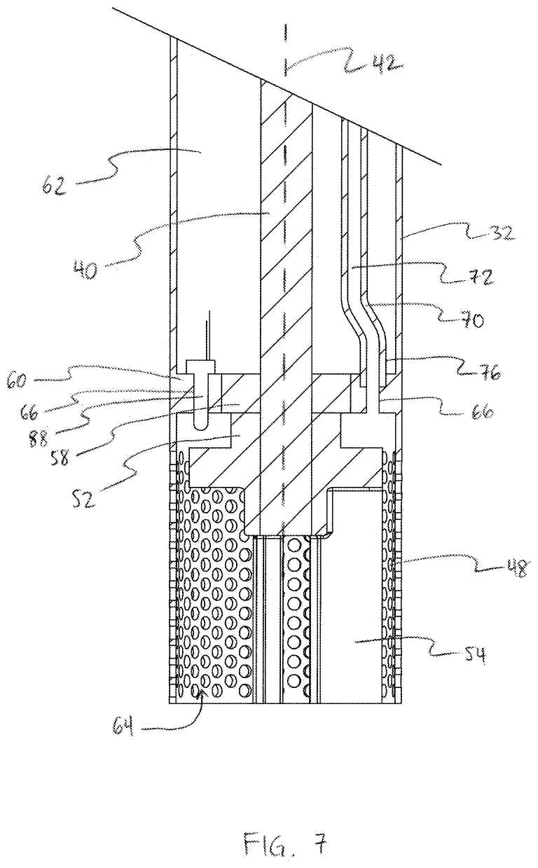

Turning to FIG. 7, the annular member 60 may, in some embodiments, include a further through hole 66 to which a temperature probe or sensor 88 may be mounted. In a preferred form, the through hole 66 for the temperature probe or sensor 88 is located diametrically opposite to the through hole 66 for the conduit 70 so as to be away from any potential heat generated therein. The temperature probe or sensor 88 may provide for direct measurement of the temperature of the milk at the area at which the impeller assembly 50 and the plurality of apertures 48 are located. It will be understood that the temperature probe or sensor 88 is in communication with electrical circuitry and a processor (not shown) of the milk texturing device 10 or of the coffee machine or other appliance so that operation of the milk texturing device 10 can be adapted in respect of duration, temperature, and speed of operation to optimise production of frothed/textured milk.

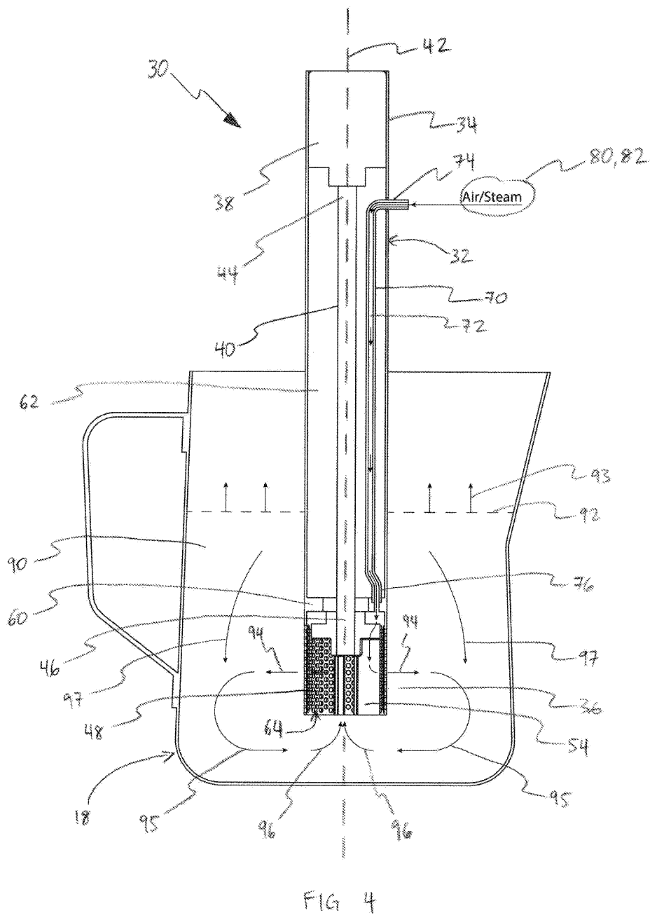

An exemplary flow pattern of milk 90 within the jug 18 from the operation of the milk texturing device 10 will now be described with reference to FIG. 4. As shown in this Figure, the rotation of the impeller assembly 50 (about the longitudinal axis 42) and/or the introduction of steam or air to the milk 90 within the jug 18 (from the steam supply 80 or the air supply 82 through the passage 72 of the conduit 70) causes a level or surface 92 of the milk 90 to rise in a direction 93 due to the incorporation of air bubbles into the milk 90. The above action(s) may cause circulation of the milk 90 such that the milk 90 moves angularly about the longitudinal axis 42 in a direction 94 which is generally in a radially outward direction away from the longitudinal axis 42. The above action(s) may also cause the milk 90 to circulate to form opposing annular vortexes 95. The vortexes 85 may be annular with respect to the axis 42 with the milk 90 circulating in the directions as indicated in FIG. 4.

In particular, when engaged by the rotating blades or vanes 54 of the impeller assembly 50, the milk 90 is caused to move outwardly away from the plurality of apertures 48 (i.e. the perforated or caged portion of the texturing wand 32) so as to have a radial component and a longitudinal component relative to the axis 42. Circulation of the milk 90 may also provide for delivery of the milk 90 upwardly to the second annular space 64 of the texturing wand 32 in the direction indicated generally by arrows 96, from a position adjacent the base of the jug 18 and generally centrally of the jug 18. Circulation of the milk 90 may also provide for the return of the milk 90 from its surface 92 towards the base of the jug 18 in a direction 97. It will thus be appreciated from the exemplary flow patterns shown in the Figures that the milk 90 may be circulated reasonably evenly in the jug 18 for a good distribution of air and/or steam throughout the milk 90. As a matter of context, in a typical texturing cycle of a volume of full-cream milk, for example, the operation of the milk texturing device 10 may result in an approximately 10 to 100% increase in the milk volume or height (pre-texturing vs post-texturing).

It will be understood that in embodiments whereby the stem assembly 14 provides for height adjustability, the raising and lowering of the head assembly 16 discussed above also results in the raising and lowering of the texturing assembly 30. In this regard, it will be appreciated that the texturing assembly 30 may be raised so that the plurality of apertures 48 are closer to the surface of the milk (as opposed to near the floor of the jug) during texturing. This may be useful when texturing large volumes of milk, where the vortex/turbulence may not extend to the surface of the milk if the impeller assembly 50 is too deep and as such, raising the texturing assembly 30 may allow for air bubbles on the surface of the milk to be pulled back down into the impeller and re-integrated.

A method of operating the milk texturing device 10 to texture/froth milk will now be described with reference to FIG. 13. At step 100, a user may input one or more settings (including, but not limited to, texture level, temperature level, milk type, and so on) into the milk texturing device 10 (or the coffee machine in which the milk texturing device 10 may be incorporated or a device/application that is connected to the device 10 or the coffee machine). At step 105, the signal communicated to the processor from this input causes the motor 19 to drive the stem assembly 14 to lower the head assembly 16 (and thereby the texturing assembly 30 with the texturing wand 32) into the jug 18. It will be understood that one or both of these steps 100 and 105 may be omitted in a manually-operated milk frothing device 10. It will also be understood that at least step 105 may be omitted in an embodiment where the stem assembly 14 does not provide for height adjustability of the head assembly 16 relative to the base assembly 12 (e.g. in an embodiment whereby the head assembly 16 is fixed relative to the base assembly 12 and the texturing assembly 30 may pivot relative to the head assembly 16).

At step 110, the texturing/frothing cycle of the milk texturing device 10 is commenced by enabling the operation of the motor 38 of the texturing assembly 30 at step 115. As discussed above, this action causes the rotation of the impeller assembly 50 (about the longitudinal axis 42) to cause circulation of the milk 90 within the jug 18. In some embodiments, the air valve 86 may then be optionally opened at step 120 to cause the introduction of air to the milk 90 within the jug 18 (from the steam the air supply 82 through the passage 72 of the conduit 70).

Once a desired level or quality of milk texture is reached from the incorporation of air bubbles into the milk 90 (or once a period of time has elapsed), the air valve 86 may be closed at step 125 and the motor 38 of the texturing assembly 30 may be disabled or stopped at step 130, thereby completing the texturing cycle at step 135. It will be appreciated that the motor 38 may alternatively continue to run for a period of time at step 138 until the user is ready to pour the milk 90 (or until the desired level or quality of milk texture is reached). This step may at least allow for the continued integration of air into the milk 90 so as to avoid separation thereof.

It will be appreciated that, between steps 125 and 130, an optional steaming cycle 140 may be included to heat the milk 90 within the jug 18. In this optional steaming cycle 140, following the closure of the air valve 86 and whilst the motor 38 is still running, the steam valve 84 may be opened to introduce steam to the milk 90 within the jug 18 (from the steam supply 80 through the passage 72 of the conduit 70). It will be understood that the steaming cycle 140 is optional and may be omitted for the preparation of milk for cold beverages, for example. The steaming cycle 140 may be ended by closing the steam valve 84 at step 148, when a desired or set temperature of the milk 90 is reached (e.g. by way of the temperature probe or sensor 90 detecting the temperature of the milk 90).

An optional cleaning cycle of the milk texturing device 10 will now be described. At step 150, following the end of the texturing cycle at step 135, the milk texturing device 10 is readied for the cleaning cycle, which begins with the raising of the texturing wand 32 out of the jug 18 at step 155. The steam valve 84 may then be opened at step 160 to introduce steam from the steam supply 80 through the passage 72 of the conduit 70, and to thereby cause steam to flow through the plurality of apertures 48 of the texturing wand 32. The motor 38 of the texturing assembly 30 may also be run at a low speed (e.g. at approximately 5000 rpm) at step 165. The running of the motor 38 and the introduction of steam from the steam supply 80 may also be timed at a set duration at step 170 to allow for sufficient cleaning of the texturing wand 32. The steam valve 84 may be closed at step 175 and the motor 38 may be stopped at step 180 to end the cleaning cycle at step 185.

It will be appreciated that one or more of the steps of the texturing and/or cleaning cycles described above may be semi-automated or fully-automated by incorporating one or more feedback mechanisms into the device 10 or other appliance. For example, the processor of the device 10 may be programmed to automatically lower the head assembly 16 following the detection of the jug 18 on the base assembly 12, and to raise the head assembly 16 following the completion of the texturing cycle and to prepare for the cleaning cycle. As discussed above, the air valve 86 may be configured to automatically close once a desired level of milk texture is achieved (which may be determined by knowing the volume of air that has been introduced to the milk over a period of time or by the detection of one or more physical properties of the milk). In the optional steaming cycle 140 described above, the steam valve 84 may also be configured to automatically open following the closure of the air valve 86 and to automatically close once a desired milk temperature is achieved (which may be determined by the detection of the milk temperature via the temperature probe or sensor). It will be understood that the automation of the milk texturing device 10 is not necessarily limited to the examples described above, and may be adjusted depending on the design requirements of the milk texturing device 10 (or the coffee machine or other appliance in which the milk texturing device 10 may be incorporated).

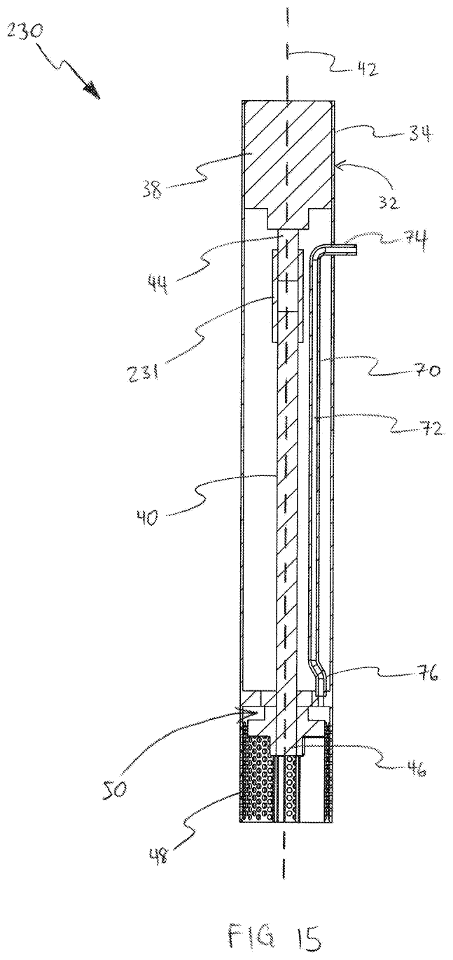

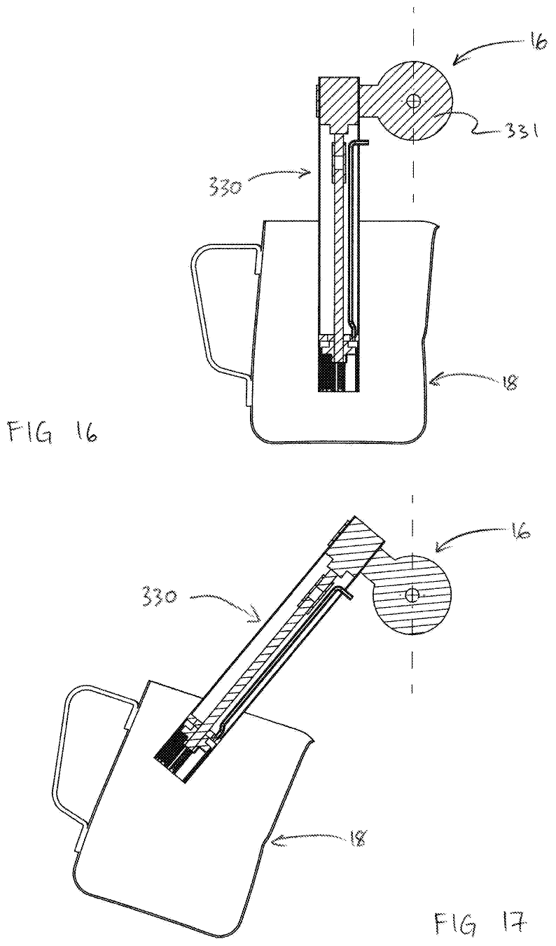

In FIG. 15 of the accompanying drawings, there is schematically depicted an embodiment of a texturing assembly 230 and components thereof. It will be appreciated that the texturing assembly 230 functions in a generally similar manner to the texturing assembly 30 described above, with like reference numerals being used to indicate like features. In the interest of clarity, the description of the like features of this embodiment will not be repeated, and it will be understood that any one or more of the like features or functions of the embodiment of the texturing assembly 30 described above are applicable to the embodiment of the texturing assembly 230, and vice versa.

In this embodiment of the texturing assembly 230, a flexible coupling or sleeve 231 may be mounted to the shaft 40. The flexible coupling or sleeve 231 may be located adjacent the motor 38 and may be formed from silicone or other suitable material. It will be appreciated that the flexible coupling or sleeve 231 may improve usability during operation and allow for misalignment during assembly. It is understood that in typical assemblies, the motor, shaft, and bearing have to be assembled perfectly and any misalignment may result in a loud noises and/or vibrations during operation. Such vibrations may reduce the quality of the frothed/textured milk. In embodiments whereby the flexible coupling or sleeve 231 is included, it will be appreciated that the flexible coupling or sleeve 231 may at least take up the “slack” in alignment tolerances between the motor shaft and the (output) shaft 40, for example, thereby allowing for a reduction in loud noises and/or vibrations during operation.

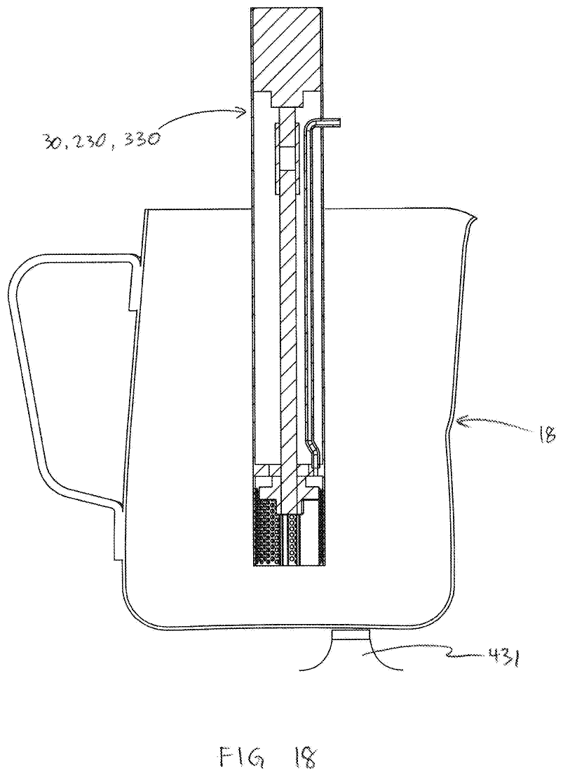

In FIGS. 16 and 17 of the accompanying drawings, there is schematically depicted an embodiment of a texturing assembly 330 and components thereof. It will be appreciated that the texturing assembly 330 functions in a generally similar manner to the texturing assemblies 30 and 230 described above, with like reference numerals being used to indicate like features. In the interest of clarity, the description of the like features of this embodiment will not be repeated, and it will be understood that any one or more of the like features or functions of the embodiment of the texturing assemblies 30 and 230 described above are applicable to the embodiment of the texturing assembly 330, and vice versa.

In this embodiment, the head assembly 16 of the device 10 is configured to include a pivoting mechanism 331 such that the texturing assembly 330 may be pivotable between a lowered position as shown in FIG. 16 and a raised position as shown in FIG. 17. This embodiment may at least allow the user to place and remove the jug 18 without necessarily requiring a height adjustment (up/down) mechanism, as the angle or position of the texturing assembly 330 may be varied by pivoting. In such embodiments, the stem assembly 14 may not necessarily require the lead screw 20 and/or the guide rod 22 and may be provided in a fixed position relative to the base assembly 12.

In FIG. 18 of the accompanying drawings, there is schematically depicted an embodiment whereby a base assembly 12 of the milk texturing device 10 (or other appliance to which it is incorporated) may be provided with a temperature sensor 431. The temperature sensor 431 may be in the form of a Negative Temperature Coefficient (NTC) sensor, for example. In this embodiment, the temperature 431 is located below the texturing assembly and below the jug 18 in use, and is adapted to detect a temperature of the jug 18 and/or the milk in the jug 18. The temperature sensor 431 may be operatively associated with the processor of the device 10 (or other appliance) so as to be provide temperature data at or during any one or more of the operational steps described above and as shown in FIG. 13.

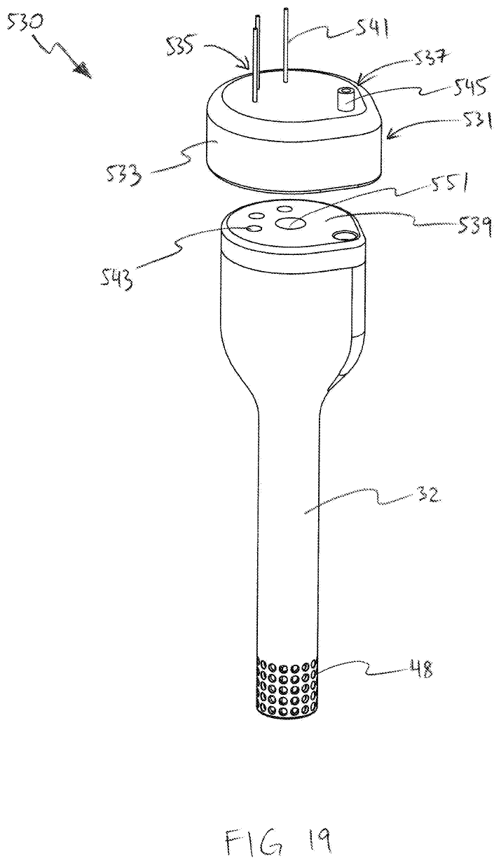

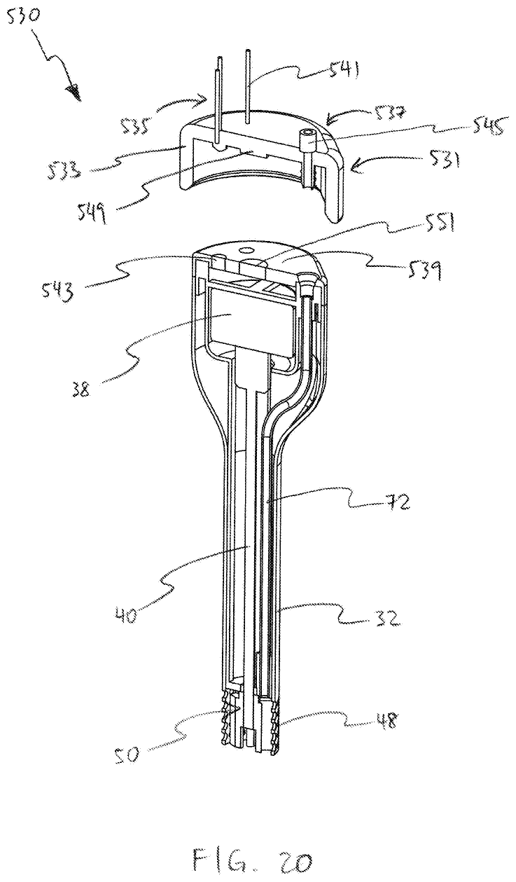

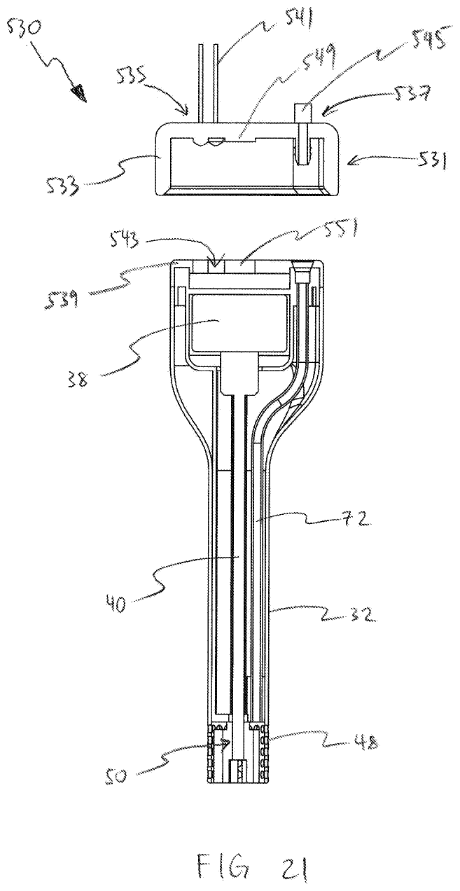

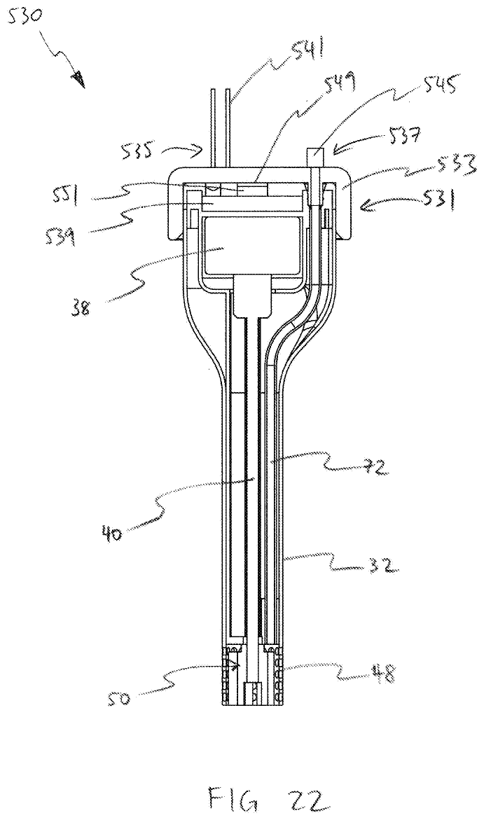

In FIGS. 19 to 23 of the accompanying drawings, there is schematically depicted an embodiment of a texturing assembly 530 and components thereof. It will be appreciated that the texturing assembly 530 functions in a generally similar manner to the texturing assemblies 30, 230, and 330 described above, with like reference numerals being used to indicate like features. In the interest of clarity, the description of the like features of this embodiment will not be repeated, and it will be understood that any one or more of the like features or functions of the embodiment of the texturing assemblies 30, 230, and 330 described above are applicable to the embodiment of the texturing assembly 530, and vice versa.

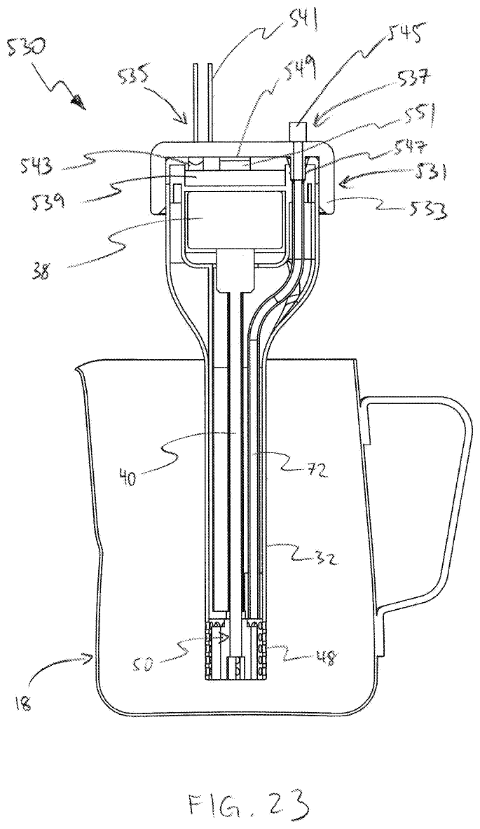

In this embodiment, the texturing assembly 530 is configured to be detachable or removable from the milk texturing device 10 (or from the coffee machine or other appliance). The texturing assembly 530 (or the head assembly 16 of the milk texturing device 10 or the coffee machine or other appliance) in this embodiment includes a connector 531 having a connector body 533, an electrical supply portion 535, and an air/steam supply portion 537, whereby the connector 531 is separately formed from the texturing wand 532. FIGS. 19 to 21 show the connector 531 separated from the texturing wand 532, whilst FIGS. 22 to 23 show the connector 531 coupled to the texturing wand 532. In other embodiments (not shown), the connector 531 may be integrated into the texturing assembly 430 (or the head assembly 16 of the milk texturing device 10 or the coffee machine or other appliance).

The connector 531 may be arranged to couple to the texturing wand 532 which, in this embodiment, includes a cover or covered upper portion 539. The cover or covered upper portion 539 may be separately or integrally formed with the body of the texturing wand 532, depending on the design requirements of the texturing assembly 530.

The electrical supply portion 535 of the connector 531 may include one or more electrical connection members 541, such as spring pins or the like, that are operatively associated with one or more corresponding electrical connection members 543 of the cover or covered upper portion 539. In the embodiment shown, the spring pins 541 include electrical contacts that engage the corresponding electrical connection members 543 to allow for electrical connection between the milk texturing device 10 (or the coffee machine or other appliance) and the texturing assembly 530. The air/steam supply portion 537 of the connector 531 may include an air/steam supply port 545 that is operatively associated with a corresponding air/steam supply port 547 of the cover or covered upper portion 539 to allow for air/steam supply from the milk texturing device 10 (or the coffee machine or other appliance) to the texturing wand 532.

The connector body 533 is arranged to couple with the texturing wand 532 such that it engages the cover or covered upper portion 539. The connector 531 may also include a magnetic coupling portion 549 that is operatively associated with a corresponding magnetic coupling portion 551 of the cover or covered upper portion 539 to facilitate the coupling/engagement between the connector 531 and the texturing wand 532. In use, the electrical supply portion 535, air/steam supply portion 537, and magnetic coupling portion 549 of the connector 531 engage the corresponding electrical connection members 543, air/steam supply port 547, and magnetic coupling portion 551 of the cover or covered upper portion 539,r respectively, such that the texturing wand 532 is secured to the connector 531 (e.g. as shown in FIGS. 22 and 23). It will be appreciated that the above arrangement of the detachable or removable texturing assembly 530 may at least allow the user an option of removing the texturing wand 532 for ease of cleaning and/or maintenance. In this embodiment, the motor 38 (and/or other electrical members) may be housed in a waterproof compartment to allow the texturing assembly 530 to safely contact water during cleaning.

Various forms of the milk texturing device described above may have one or more of the following advantages. It will be appreciated that the rotation of the impeller assembly (typically at a high speed), coupled with the introduction of air into the milk from the conduit, may at least allow for a high level of air or air bubbles being introduced into and evenly distributed throughout the milk so as to provide a desirable milk texture. It will also be appreciated that this arrangement may also allow for reasonably good level of cold milk texturing for a variety of milks with differing levels of fat or protein content (e.g. full cream milk vs. soy milk, oat milk, almond milk, and the like). As the introduction of air may occur independently of steam, which is optional, it is possible to achieve adequately textured milk for the preparation of cold beverages. The supply of steam, whilst being an optional feature for the preparation of hot beverages, may be directed via the same conduit or fluid passage utilised by the air supply. This arrangement may also allow for ease of cleaning of the texturing wand. The milk texturing device is also envisaged to be at least partly automated to allow for simple and efficient operation.

Although specific embodiments of the invention are illustrated and described herein, it will be appreciated by those of ordinary skill in the art that a variety of alternative and/or equivalent implementations exist. It should be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that in this document the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise. Moreover, the terms “first”, “second”, etc. are used merely as labels, and are not intended to impose numerical requirements on or to establish a certain ranking of importance of their objects.

List of reference numerals

| | |
|---|---|
| 10 | Milk texturing device |
| 12 | Base assembly |
| 14 | Stem assembly |
| 16 | Head assembly |
| 18 | Milk jug |
| 19 | Motor of base assembly |
| 20 | Lead screw |
| 22 | Guide rod |
| 30 | Texturing assembly |
| 32 | Texturing wand |
| 34 | First end portion of texturing wand |
| 36 | Second end portion of texturing wand |
| 38 | Motor of texturing assembly |
| 40 | Shaft |
| 42 | Longitudinal axis |
| 44 | First end portion of shaft |
| 46 | Second end portion of shaft |
| 48 | Plurality of apertures |
| 50 | Impeller assembly |
| 52 | Hub |
| 54 | Blades or vanes |
| 56 | Central aperture of hub |
| 58 | Bearing member |
| 60 | Annular member |
| 62 | First annular space |
| 64 | Second annular space |
| 66 | Through holes |
| 70 | Conduit or tube |
| 72 | Passage |
| 74 | First (inlet) end portion |
| 76 | Second (outlet) end portion |
| 78 | Aperture |
| 80 | Steam supply |
| 82 | Air supply |
| 84 | Steam valve |
| 86 | Air valve |
| 88 | Temperature sensor or probe |
| 90 | Milk |
| 92 | Level or surface of milk |
| 93 | Direction |
| 94 | Further direction |
| 95 | Annular vortexes |
| 96 | Further direction or arrows |
| 97 | Further direction |
| 100 | User input step |
| 105 | Wand lowering step |
| 110 | Texturing cycle commencement step |
| 115 | Start motor step |
| 120 | Air valve open step |
| 125 | Air valve close step |
| 130 | Stop motor step |
| 135 | Texturing cycle completed step |
| 140 | Optional steam cycle step |
| 145 | Open steam valve step |
| 138 | Close steam valve step |
| 150 | Cleaning cycle step |
| 155 | Wand raising step |
| 160 | Open steam valve step |
| 165 | Run motor step |
| 170 | Run motor and steam step |
| 175 | Close steam valve step |
| 180 | Stop motor step |
| 185 | Cleaning cycle completed step |
| 230 | Texturing assembly |
| 231 | Flexible coupling or sleeve |
| 330 | Texturing assembly |
| 331 | Pivoting mechanism |
| 431 | Temperature sensor |
| 530 | Texturing assembly |
| 531 | Connector |
| 532 | Texturing wand |
| 533 | Connector body |
| 535 | Electrical supply portion |
| 537 | Air/steam supply portion |
| 539 | Cover or covered upper portion |
| 541 | Electrical connection members |
| 543 | Electrical connection members |
| 545 | Air/steam supply port |
| 547 | Air/steam supply port |
| 549 | Magnetic coupling portion |
| 551 | Magnetic coupling portion |

1. A milk texturing device for texturing milk in a container, the device including:
a base assembly;
a stem assembly extending from the base assembly;
a head assembly mountable to the stem assembly; and
a texturing assembly mountable to the head assembly and including:
a motor having an output shaft that is rotatably driven about a longitudinal axis of the shaft;
an impeller assembly rotatably driven by the shaft and arranged to be submerged in the milk in the container during use, wherein rotation of the impeller assembly causes circulation of milk within the container; and
a wand extending along the longitudinal axis and having an open end portion that at least partly surrounds the impeller assembly,
wherein the milk texturing device further includes a conduit defining a passage for fluid flow and configured to provide fluid communication between a fluid supply and the open end portion of the wand and thereby to the impeller assembly.

2. The milk texturing device according to claim 1, wherein the fluid supply is one or more of an air supply, a steam supply, or open to atmosphere, and the fluid supply includes one or more valves that are actuatable to provide selective fluid communication with the conduit.

3. The milk texturing device according to claim 1 or 2, wherein the wand includes a first annular space through which the conduit extends and a second annular space within which the impeller assembly is located.

4. The milk texturing device according to claim 3, wherein the conduit includes an inlet end portion in fluid communication with the fluid supply and an outlet end portion in fluid communication with the second annular space of the wand within which the impeller assembly is located.

5. The milk texturing device according to claim 3 or 4, wherein the wand further includes an annular member disposed between the first annular space and the second annular space to provide a seal therebetween.

6. The milk texturing device according to claim 5, wherein the seal between the first annular space and the second annular space is provided by a bearing member mountable to the annular member.

7. The milk texturing device according to any one of the preceding claims, wherein the conduit extends along a longitudinal axis that is parallel to the longitudinal axis of the shaft.

8. The milk texturing device according to any one of the preceding claims, wherein the end portion of the wand includes a plurality of apertures providing a perforated or caged member through which the milk may flow.

9. The milk texturing device according to claim 7, wherein each of the apertures have a diameter of at least 0.3 mm.

10. The milk texturing device according to claim 8, wherein each of the apertures have a diameter of between 0.3 and 1.0 mm.

11. The milk texturing device according to any one of the preceding claims, further including a temperature sensor disposed adjacent the end portion of the wand.

12. The milk texturing device according to claim 11, wherein the temperature sensor is located diametrically opposite to the conduit about the longitudinal axis.

13. The milk texturing device according to any one of claims 1 to 12, wherein the head assembly is movable between a raised position and a lowered position relative to the base assembly.

14. The milk texturing device according to any one of claims 1 to 12, wherein the head assembly is configured to allow the texturing assembly to pivot between a raised position and a lowered position relative to the base assembly.

15. The milk texturing device according to any one of the preceding claims, wherein the texturing assembly further includes a flexible coupling or sleeve mounted to the shaft.

16. The milk texturing device according to any one of the preceding claims, wherein the base assembly includes a temperature sensor to detect a temperature of milk in the container during use.

17. A method of operating a milk texturing device, the method including the steps of:
enabling a motor to drive a rotation of an impeller assembly of the milk texturing device to circulate milk in a container; and
opening an air valve of the milk texturing device to introduce air into the milk from an air supply.

18. The method according to claim 17, wherein the method further includes the step of:
prior to enabling the motor, receiving a user input relating to one or more settings relating to a texture level or temperature of the milk being textured.

19. The method according to claim 17 or 18, wherein the method further includes the steps of:
determining a quality of the milk being textured; and
closing the air valve of the milk texturing device after the milk being textured reaches a certain texture level.

20. The method according to claim 17 or 18, wherein the method further includes the step of:
closing the air valve of the milk texturing device after the air valve has been open for a period of time.

21. The method according to claim 20, wherein the method further includes the step of:
opening a steam valve of the milk texturing device to introduce steam into the milk from a steam supply to thereby heat the milk.

22. The method according to claim 21, wherein the method further includes the step of:
closing the steam valve of the milk texturing device after the milk being textured reaches a certain temperature.

23. The method according to any one of claims 17 to 22, wherein the method further includes the step of:
disabling the motor and thereby rotation of the impeller assembly to complete a texturing cycle of the milk texturing device.

24. The method according to claim 23, wherein the method further includes the step of commencing a cleaning cycle following the completion of the texturing cycle, wherein the cleaning cycle includes the steps of:
opening the steam valve of the milk texturing device; and
enabling the motor to drive rotation of the impeller assembly at a low speed.

25. The method according to claim 24, wherein the steam valve is opened and the motor is configured to drive the rotation of the impeller assembly for a period of time.

26. The method according to claim 25, wherein the method further includes the step of:
closing the steam valve following the opening of the steam valve and the rotation of the impeller assembly for the period of time; and
disabling the motor and thereby the rotation of the impeller assembly to complete the cleaning cycle of the milk texturing device.

27. A non-transitory computer storage medium storing instructions that, when executed by one or more processors of a milk frothing device according to any one of claims 13 to 16, causes the one or more processors to perform a method of operating the milk frothing device.

28. A texturing assembly for texturing or frothing milk in a container, the texturing assembly including:
a wand having an end portion including a plurality of apertures;
an impeller assembly having a central longitudinal axis and including a plurality of vanes, the impeller assembly being powered by a drive unit, and the plurality of vanes being surrounded by the plurality of apertures; and
a conduit defining a passage for steam or air flow, wherein the conduit extends along a longitudinal axis that is generally parallel to the central longitudinal axis of the impeller assembly.

29. The texturing assembly according to claim 28, wherein a portion of the conduit extends in a direction transverse to the longitudinal axis.

30. A method of texturing milk in a container using a texturing assembly, the method including the steps of:
rotating an impeller assembly of the texturing assembly to circulate milk in the container;
introducing steam or air into the milk via a wand of the texturing assembly, the wand having an end portion including a plurality of apertures surrounding the impeller assembly; and
texturing the milk by circulating the milk through the plurality of apertures surrounding the impeller assembly.
